(19) United States
(12) Patent Application Publication
(10) Pub. No.: US 2026/0230194 A1
(43) Pub. Date: Aug. 6, 2026

(54) WAVE MATRIX-BASED CASCADED METASURFACE ELECTROMAGNETIC TRANSMISSION MODELING AND ANALYSIS METHOD, AS WELL AS CASCADED METASURFACE

(71) Applicant: Shanghai University, Shanghai (CN)

(72) Inventors: Fengyuan YANG, Shanghai (CN); Yuchen SUO, Shanghai (CN); Jiale DU, Shanghai (CN); Nan WANG, Shanghai (CN)

(21) Appl. No.: 19/632,153

(22) Filed: Mar. 27, 2026

(30) Foreign Application Priority Data
Nov. 24, 2025 (CN) 202511726529.6

(51) Int. Cl. H04B 17/10; H01Q 15/00; H04B 17/20

(52) U.S. Cl. CPC H04B 17/102; H01Q 15/0086; H04B 17/202

(57) ABSTRACT

The present disclosure discloses a wave matrix-based cascaded metasurface electromagnetic transmission modeling and analysis method, as well as a cascaded metasurface, which belong to the field of high-frequency communication and artificial electromagnetic metasurface technology. The method takes wave matrix theory as the core, the cascaded structure contains dielectric spacers and n thin-sheet admittance layers, the total electric field is the sum of forward and backward propagation fields, combined with the 90° rotation matrix, the magnetic field expression is obtained. It is equivalent to a four-port network, correlating the wave matrix with the scattering and transmission matrices, the wave matrices of each layer are combined to obtain the overall wave matrix, an isolating dielectric is introduced for correction, and the parameters are solved to complete the modeling.

### TECHNICAL FIELD

The present disclosure relates to the field of high-frequency communication and artificial electromagnetic metasurface technology, specifically concerning a wave matrix-based cascaded metasurface electromagnetic transmission modeling and analysis method, as well as a cascaded metasurface.

### BACKGROUND

Over years of development, metasurface technology has demonstrated continuously enhanced capabilities in electromagnetic wave manipulation and an increasing diversity of functionalities, establishing itself as a critical research direction in modern electromagnetic engineering. As artificial electromagnetic structures characterized by subwavelength thickness, compact configuration, ease of fabrication and integration, metasurfaces enable flexible control over key wave parameters including phase, amplitude, and polarization state, they exhibit remarkable performance in spatial beam shaping, reflection control, and signal modulation; in wireless communications, metasurface technology offers effective regulation of propagation paths and waveforms, providing new approaches for improving signal quality and optimizing coverage, particularly demonstrating significant advantages in scenarios such as indoor signal reconstruction and compensation for coverage blind zones. Furthermore, with the advancement of sixth-generation mobile communication research, operational frequencies are progressively shifting from conventional microwave bands toward high-frequency microwave and millimeter-wave regimes.

However, existing technologies exhibit the following limitations: Although current metasurface technologies can achieve reflection suppression under specific frequency bands and ideal conditions, they fall short of meeting the requirements for “multi-angle, multi-medium, and multi-functional cooperative transmission” in complex scenarios. A universally applicable system design framework adaptable to diverse scenarios remains absent; when electromagnetic signals penetrate building facades such as glass curtain walls, a significant impedance mismatch between air and construction materials induces strong reflection and shielding effects, resulting in low effective signal transmissivity and compromising communication continuity as well as system capacity. Current approaches that compensate for signal attenuation through dense deployment of indoor repeaters and small cells suffer from complex deployment, high costs, and significant maintenance burdens, failing to align with the development trend toward “lightweight and intelligent” communication infrastructure. Furthermore, most metasurfaces fail to account for mechanical adaptability in architectural contexts, lacking flexible and low-profile designs necessary for large-scale deployment on complex building surfaces, nor have they explored transparent characteristics to accommodate the aesthetic requirements of glass curtain walls and similar applications.

Therefore, a new approach is urgently needed.

### SUMMARY

An objective of this disclosure is to provide a wave matrix-based cascaded metasurface electromagnetic transmission modeling and analysis method, as well as a cascaded metasurface. This method achieves flexible control within −3 dB bandwidth in a radio frequency (RF), microwave, and millimeter-wave bands under oblique incidence ranging from 0° to 80°, establishing a signal enhancement system framework across building surfaces; this method improves the transmission efficiency of electromagnetic waves through glass curtain walls while reducing deployment and maintenance costs. Furthermore, this method endows metasurfaces with mechanical adaptability, enhancing compatibility with glass curtain walls and supporting large-scale deployment in complex scenarios.

To achieve the above objective, this present disclosure provides a wave matrix-based cascaded metasurface electromagnetic transmission modeling and analysis method, as well as a cascaded metasurface, specifically as follows:

A cascaded structure is defined as consisting of dielectric spacers and n thin-sheet admittance layers, where a total electric field within each region is considered as a sum of a forward propagation field

$${E}_{i}^{+}$$

and a backward propagation field

$${E}_{i}^{-} ,$$

expressed as:

$${E}_{i} = {E}_{i}^{+} + {E}_{i}^{-} ; \\ {E}_{i}^{+} = {[ {E}_{ix}^{+} {E}_{iy}^{+} ]}^{T} ; \\ {E}_{i}^{-} = {[ {E}_{ix} {E}_{iy}^{-} ]}^{T} ;$$

where Eᵢ denotes the total electric field within the region,

$${E}_{ix}^{+}$$

denotes an x-direction component of a forward propagation electric field in region i;

$${E}_{iy}^{+}$$

denotes a y-direction component of the forward propagation electric field in region i;

$${E}_{ix}^{-}$$

denotes an x-direction component of a backward propagation electric field in region i, and

$${E}_{iy}^{-}$$

denotes a y-direction component of the backward propagation electric field in region i;
a corresponding magnetic field expression is derived by incorporating a 90° rotation matrix, establishing a mathematical relationship between the total electric field and magnetic field in region i, expressed as:

$${H}_{i}^{+} = \frac{1}{{η}_{i}} n {E}_{i}^{+} , {H}_{i}^{-} = - \frac{1}{{η}_{i}} {nE}_{i}^{-} ; \\ n = [ \begin{matrix}0 & - 1 \\ 1 & 0\end{matrix} ] ;$$

where n denotes the 90° rotation matrix;

$${E}_{i}^{+}$$

denotes a forward propagation electric field vector in region i;

$${E}_{i}^{-}$$

denotes a backward propagation electric field vector in region i;

$${H}_{i}^{+}$$

denotes a forward propagation magnetic field vector in region i;

$${H}_{i}^{+}$$

denotes a backward propagation magnetic field vector in region i; ηᵢ denotes an intrinsic impedance;
a total magnetic field is expressed as:

$${H}_{i} = {H}_{i}^{+} + {H}_{i}^{-} = \frac{1}{{η}_{i}} n ( {E}_{i}^{+} - {E}_{i}^{-} ) ;$$

where Hᵢ denotes a total magnetic field in region i;
the cascaded structure is equivalent to a four-port network, the ports are arranged in region 1 and region n+1, and x-polarization along with y-polarization are considered at the same time, a 4×4 microwave network parameter matrix is constructed to establish a correlation between an incident wave and a reflected wave;
using a wave matrix to correlate with a scattering matrix and a transmission matrix respectively, where the scattering matrix correlates the incident wave with the reflected wave of region 1 and region n+1, the transmission matrix correlates the total electric field and magnetic field of region 1 and region n+1, the wave matrix directly correlates an incident/reflected field of region 1 and a field of region n+1;
wave matrices for the i-th interface and dielectric spacers are defined, according to a definition of wave matrix, the forward/backward propagation field of region i is correlated with the field of region i+1, and a total wave matrix of cascaded structure is obtained by combining wave matrices of n−1 dielectric spacers and n thin-sheet admittance layers through matrix multiplication; the total wave matrix of the cascaded structure is expressed as:

$$( \begin{matrix}{E}_{i}^{+} \\ {E}_{i}^{-}\end{matrix} ) = {𝕄}_{inter}^{( 1 )} {𝕄}_{delay}^{( 2 )} {𝕄}_{inter}^{( 2 )} … {𝕄}_{delay}^{( n )} {𝕄}_{inter}^{( n )} ( \begin{matrix}{E}_{n + 1}^{+} \\ {E}_{n + 1}^{-}\end{matrix} ) ;$$

where

$${𝕄}_{inter}^{( n )}$$

denotes a wave matrix of the n-th interface;

$${𝕄}_{delay}^{( n )}$$

denotes a wave matrix of the n-th dielectric delay;
based on boundary conditions, a wave matrix of an interface of the i-th layer is derived, and a wave matrix expression of each component is derived according to scenes, under an assumption of plane wave propagation in the dielectric spacers, a wave matrix of the dielectric spacer is calculated;
after last layer of metasurface, an isolation medium is introduced to modify expression of the total wave matrix and the associated scattering matrix of the cascaded structure, the wave matrix of the interface and the wave matrix of the dielectric spacer are substituted into a modified expression to solve key parameters that characterize an electromagnetic response and complete the modeling.

In some embodiments, a scattering matrix S is expressed as:

$$( \begin{matrix}{E}_{1}^{-} \\ {E}_{n + 1}^{+}\end{matrix} ) = ( \begin{matrix}{S}_{11} & {S}_{12} \\ {S}_{21} & {S}_{22}\end{matrix} ) ( \begin{matrix}{E}_{1}^{+} \\ {E}_{n + 1}^{-}\end{matrix} ) ;$$

where

$${E}_{1}^{-}$$

denotes a backward propagation electric field vector in region 1;

$${E}_{n + 1}^{+}$$

denotes a forward propagation electric field vector in region n+1;

$${E}_{1}^{+}$$

denotes a forward propagation electric field vector in region 1;

$${E}_{n + 1}^{-}$$

denotes a backward propagation electric field vector in region n+1;

$$( \begin{matrix}{S}_{11} & {S}_{12} \\ {S}_{21} & {S}_{22}\end{matrix} )$$

denotes the scattering matrix, the scattering matrix is used to describe a parameter matrix of electromagnetic scattering characteristics of the four-port network.

In some embodiments, the transmission matrix ABCD is expressed as:

$$( \begin{matrix}{E}_{1}^{+} + {E}_{1}^{-} \\ \frac{1}{{η}_{i}} n ( {E}_{1}^{+} - {E}_{1}^{-} )\end{matrix} ) = ( \begin{matrix}A & B \\ C & D\end{matrix} ) ( \begin{matrix}{E}_{n + 1}^{+} + {E}_{n + 1}^{-} \\ \frac{1}{{η}_{i + 1}} n ( {E}_{n + 1}^{+} - {E}_{n + 1} )\end{matrix} ) ;$$

where

$$( \begin{matrix}A & B \\ C & D\end{matrix} )$$

denotes the transmission matrix, the transmission matrix is used to describe a parameter matrix of the electromagnetic transmission characteristics of the four-port network.

In some embodiments, the wave matrix is expressed as:

$$( \begin{matrix}{E}_{1}^{+} \\ {E}_{1}^{-}\end{matrix} ) = ( \begin{matrix}{M}_{11} & {M}_{12} \\ {M}_{21} & {M}_{22}\end{matrix} ) ( \begin{matrix}{E}_{n + 1}^{+} \\ {E}_{n + 1}^{-}\end{matrix} ) ;$$

where

$$( \begin{matrix}{M}_{11} & {M}_{12} \\ {M}_{21} & {M}_{22}\end{matrix} )$$

denotes the wave matrix, the wave matrix is a parameter matrix used to describe a relationship between forward and backward electric field vectors in different regions of the cascaded metasurface electromagnetic structure.

In some embodiments, it also includes a transformation of traditional network parameters to a wave matrix, specifically as follows:

$$𝕄 = {𝕊}_{1} {𝕊}_{2}^{- 1} = ( \begin{matrix}I & 0 \\ {S}_{11} & {S}_{12}\end{matrix} ) {( \begin{matrix}{S}_{21} & {S}_{22} \\ 0 & I\end{matrix} )}^{- 1} ;$$

$$𝕄 = \frac{1}{2} ( \begin{matrix}I & - {η}_{1} n \\ I & {η}_{1} n\end{matrix} ) ( \begin{matrix}A & B \\ C & D\end{matrix} ) ( \begin{matrix}I & I \\ \frac{1}{{η}_{n + 1}} n & - \frac{1}{{η}_{n + 1}} n\end{matrix} ) ;$$

where

$${𝕊}_{1} {𝕊}_{2}^{- 1}$$

denotes a block of the scattering matrix; I denotes a unit matrix; 0 denotes a zero matrix; η₁ denotes an intrinsic impedance corresponding to region 1; and ηₙ₊₁ denotes an intrinsic impedance corresponding to the region n+1.

In some embodiments, the wave matrix expression of each component is derived according to the scene, specifically as follows:

Scenario 1: When only considering an electrical response and not considering a cross-polarization, a transmission matrix of a material interface is calculated as follows:

$${𝕄}_{inter}^{( i )} = ( {T}_{i} ⊗ I + \frac{{η}_{i}}{2} e ⊗ {Y}_{i} ) ;$$

$${T}_{i} = ( 1 / t ) ( \begin{matrix}1 & r \\ r & 1\end{matrix} ) ;$$

where Tᵢ denotes a 2×2 transmission matrix of the material interface; r denotes a Fresnel reflection coefficient; t denotes a transmission coefficient;

$$e = [ \begin{matrix}1 & 1 \\ - 1 & - 1\end{matrix} ] ;$$

Yᵢ denotes a 2×2 admittance value of a surface ideal electromagnetic response

$${Y}_{i} = [ \begin{matrix}{Y}_{i}^{xx} & 0 \\ 0 & {Y}_{i}^{yy}\end{matrix} ] ;$$

⊗ denotes a Kronecker product;

Scenario 2: unit matrix and surface ideal electromagnetic response admittance value are calculated, and a calculation formula is:

$${𝕄}_{inter}^{( i )} = ( {T}_{i} ⊗ I + \frac{1}{2 {η}_{i + 1}} m ⊗ ( n {Z}_{i} n ) ) ;$$

where m denotes a matrix factor; Zᵢ denotes a surface impedance of the i-th interface;

Scenario 3: The specific boundary conditions are derived when only considering the magnetic response, and a calculation formula is:

$${𝕄}_{delay}^{( i )} = ( {Φ}_{i} ⊗ I ) ;$$

where Φᵢ denotes a phase delay matrix associated with the i-th dielectric spacer.

In some embodiments, it also includes, combined with an electrically responsive metasurface, when i=3, the total wave matrix of the cascaded structure is expressed as:

$${𝕄}_{total} = {𝕄}_{inter}^{( 1 )} {𝕄}_{delay}^{( 2 )} {𝕄}_{inter}^{( 2 )} {𝕄}_{delay}^{( 3 )} {𝕄}_{inter}^{( 3 )} ;$$

where [symbol] ₜₒₜₐₗ denotes the total wave matrix of the cascaded structure;
the scattering matrix S is associated with the total wave matrix of the cascaded structure, which is expressed as:

$${𝕄}_{total} = {𝕊}_{1} {𝕊}_{2}^{- 1} = {𝕄}_{inter}^{( 1 )} {𝕄}_{delay}^{( 2 )} {𝕄}_{inter}^{( 2 )} {𝕄}_{delay}^{( 3 )} {𝕄}_{inter}^{( 3 )} ;$$

considering a cross-medium scenario, the isolation medium is introduced after the last layer of the metasurface, and the total wave matrix and the corresponding scattering matrix S correlation of the cascaded structure are modified, which are expressed as:

$${𝕄}_{total} = {𝕄}_{inter}^{( 1 )} {𝕄}_{del ay}^{( 2 )} {𝕄}_{inter}^{( 2 )} {𝕄}_{delay}^{( 3 )} {𝕄}_{inter}^{( 3 )} {𝕄}_{delay}^{( 4 )} {𝕄}_{inter}^{( 4 )} ;$$

$${𝕄}_{delay}^{( 4 )} = ( {Φ}_{4} ⊗ I ) ;$$

$${𝕄}_{inter}^{( 4 )} = ( {T}_{4} ⊗ I ) ;$$

$${𝕊}_{1} {{𝕊}_{2}^{- 1} ( {T}_{4} ⊗ I )}^{- 1} {( {Φ}_{4} ⊗ I )}^{- 1} = {𝕄}_{inter}^{( 1 )} {𝕄}_{delay}^{( 2 )} {𝕄}_{inter}^{( 2 )} {𝕄}_{delay}^{( 3 )} {𝕄}_{inter}^{( 3 )} ;$$

where

$${𝕄}_{inter}^{( 1 )} , {𝕄}_{inter}^{( 2 )} , {𝕄}_{inter}^{( 3 )} , and {𝕄}_{inter}^{( 4 )}$$

denote wave matrices for the first, second, third, and fourth interface, respectively;

$${𝕄}_{inter}^{( 2 )} , {𝕄}_{inter}^{( 3 )} , and {𝕄}_{inter}^{( 4 )}$$

denote wave matrices for the second, third, and fourth dielectric delay, respectively; and Φ₄ denotes a phase delay matrix of the fourth dielectric spacer. T₄ denotes a transmission matrix block related to the fourth interface.

The present disclosure also provides a cascaded metasurface, the cascaded metasurface is designed based on an ideal admittance value of a “11” state, including three thin-sheet admittance layers and dielectric spacers, a flexible material, polydimethylsiloxane (PDMS), is used as a substrate, and a thickness is 0.058λ.

In some embodiments, the cascaded metasurface achieves impedance matching of an air-glass interface in the −3 dB bandwidth of the RF, microwave and millimeter-wave bands (the embodiment is 5.75-8.15 GHz broadband range).

Therefore, the present disclosure adopts the above-mentioned wave matrix-based cascaded metasurface electromagnetic transmission modeling and analysis method, as well as a cascaded metasurface. Compared with existing technology, technical schemes of the present disclosure have the following beneficial effects:
(1) The present disclosure adopts technical means of establishing a broadband equivalent coding state theoretical model and obtaining four 2-bit coding transmission states, it overcomes the technical problems of an existing metasurface control function, which is difficult to meet multi-angle, multi-medium, multi-functional collaborative transmission requirements in complex scenarios, and lacks a systematic design framework. A technical problem of the framework further realizes a flexible regulation of “broadband (5.75-8.15 GHz-3 dB bandwidth)+multi-angle (0°-80° oblique incidence still maintains good performance)”, forms a systematic design framework for cross-building surface signal enhancement, and adapts to the technical effects of complex multi-scenario requirements;
(2) the present disclosure adopts the technical means of realizing a conjugate impedance matching between air and glass based on wave matrix theory, which overcomes technical problems of low transmission efficiency of electromagnetic wave signal and “glass shielding effect” caused by the strong reflection of wave impedance discontinuity at building interfaces, thereby reducing reflection loss from a root of electromagnetic transmission mechanism, significantly improves the transmission efficiency of electromagnetic wave signal through glass curtain walls, and effectively alleviates the technical effect of “glass shielding effect”;
(3) the present disclosure adopts the technical means of designing ultra-thin (0.058λ, 2.5 mm for embodiment 5.75-8.15 GHz-3 dB bandwidth range), flexible metasurface and deploying directly on the building surfaces, which overcomes a traditional engineering compensation scheme relying on additional repeaters or small base stations. There are technical problems such as complex deployment, high cost, and significant maintenance burdens. Consequently, the present disclosure eliminates a need for additional communication auxiliary equipment, reduces deployment costs and maintenance burdens, and achieves the technical effect of aligning with a development direction of lightweight and intelligent communication infrastructure;
(4) the present disclosure employs a technical approach that utilizes PDMS as a flexible substrate material and plans to explore conformal deployment and application of transparent conductive materials. This approach overcomes the technical problems of existing metasurfaces, namely their lack of flexibility and low-profile design, which results in insufficient mechanical adaptability to building surfaces such as glass curtain walls and inadequate visual compatibility. Consequently, the present disclosure imparts mechanical adaptability to the metasurface, supports large-scale deployment on complex building surfaces, and simultaneously enhances both visual and structural compatibility with glass curtain walls.

The following is a further detailed description of the technical scheme of the present disclosure through drawings and embodiments.

### BRIEF DESCRIPTION OF THE DRAWINGS

FIG. 1 is a schematic diagram illustrating the electromagnetic wave transmission characteristics of the metasurface according to an embodiment of the wave matrix-based cascaded metasurface electromagnetic transmission modeling and analysis method, as well as a cascaded metasurface of the present disclosure;

FIG. 2 is a schematic diagram illustrating the structure design and parameters of the metasurface according to an embodiment of the wave matrix-based cascaded metasurface electromagnetic transmission modeling and analysis method, as well as a cascaded metasurface of the present disclosure; where FIG. 2 (a) and (b) show exploded three-dimensional structural views; FIG. 2 (c) shows a planar dimension diagram of each layer unit;

FIG. 3 is a simulation diagram of the electric field distribution of each layer unit of the electromagnetic metasurface according to an embodiment of the wave matrix-based cascaded metasurface electromagnetic transmission modeling and analysis method, as well as a cascaded metasurface of the present disclosure;

FIG. 4 is a frequency response comparison diagram of the transmission characteristics of the metasurface according to an embodiment of the wave matrix-based cascaded metasurface electromagnetic transmission modeling and analysis method, as well as a cascaded metasurface of the present disclosure;

FIG. 5 is a frequency response diagram of the electromagnetic enhancement characteristics of the metasurface according to an embodiment of the wave matrix-based cascaded metasurface electromagnetic transmission modeling and analysis method, as well as a cascaded metasurface of the present disclosure;

FIG. 6 is a comparison diagram of the oblique incidence transmission characteristics of the metasurface according to an embodiment of the wave matrix-based cascaded metasurface electromagnetic transmission modeling and analysis method, as well as a cascaded metasurface of the present disclosure; FIG. 6 (a) shows the transmission coefficient curves of electromagnetic waves as a function of frequency under different incident angles without the metasurface; FIG. 6 (b) shows the transmission coefficient curves as a function of frequency under different incident angles with the metasurface;

FIG. 7 is an angle-frequency response diagram of the electromagnetic enhancement characteristics of the metasurface according to an embodiment of the wave matrix-based cascaded metasurface electromagnetic transmission modeling and analysis method, as well as a cascaded metasurface of the present disclosure.

### DETAILED DESCRIPTION

To make the objectives, technical solutions, and advantages of the embodiments of the present disclosure clearer, the technical solutions of the embodiments of the present disclosure will be described clearly and completely below with reference to the drawings of the embodiments of the present disclosure. Obviously, the described embodiments are some, but not all, of the embodiments of the present disclosure. All other embodiments obtained by those of ordinary skill in the art based on the described embodiments of the present disclosure, without creative efforts, shall fall within the protection scope of the present disclosure. Unless otherwise defined, technical or scientific terms used herein shall have the ordinary meaning as understood by one of ordinary skill in the art to which the present disclosure belongs.

### Embodiment 1

The wave matrix-based cascaded metasurface electromagnetic transmission modeling and analysis method, as well as a cascaded metasurface are as follows:

It is clarified that the cascaded structure is composed of dielectric spacers and n thin-sheet admittance layers, the total electric field within each region is considered as a sum of the forward and the backward propagation field. The forward propagation field is denoted as

$${E}_{i}^{+} = {[ \begin{matrix}{E}_{ix}^{+} & {E}_{iy}^{+}\end{matrix} ]}^{T} ,$$

and the backward propagation field is denoted as

$${E}_{i}^{-} = {[ \begin{matrix}{E}_{ix}^{-} & {E}_{iy}^{-}\end{matrix} ]}^{T} ,$$

expressed as:

$${E}_{i} = {E}_{i}^{+} + {E}_{i}^{-} ;$$

where Eᵢ denotes the total electric field vector in region i,

$${E}_{ix}^{+}$$

denotes the x-direction component of the forward propagation electric field in region i;

$${E}_{iy}^{+}$$

denotes the y-direction component of the forward propagation electric field in region i;

$${E}_{ix}^{-} and {E}_{iy}^{-}$$

denotes the x-direction component of the backward propagation electric field in region i, denotes the y-direction component of the backward propagation electric field in region i;
at this time, the corresponding magnetic field expression is:

$${H}_{i}^{+} = \frac{1}{{η}_{i}} {nE}_{i}^{+} ,$$

$${H}_{i}^{-} = - \frac{1}{{η}_{i}} {nE}_{i}^{-} ;$$

$$n = [ \begin{matrix}0 & - 1 \\ 1 & 0\end{matrix} ] ;$$

where n denotes the 90° rotation matrix;

$${E}_{i}^{+}$$

denotes the forward propagation electric field vector in region i;

$${E}_{i}^{-}$$

denotes the backward propagation electric field vector in region i;

$${H}_{i}^{+}$$

denotes the forward propagation magnetic field vector in region i;

$${H}_{i}^{+}$$

denotes the backward propagation magnetic field vector in region i; ηᵢ denotes the intrinsic impedance;
the total magnetic field is expressed as:

$${H}_{i} = {H}_{i}^{+} + {H}_{i}^{-} = \frac{1}{{η}_{i}} n ( {E}_{i}^{+} - {E}_{i}^{-} ) ;$$

where Hᵢ denotes the total magnetic field in region i;
the cascaded structure is regarded as a four-port network (the port is located in the region 1 and the region n+1, taking into account the x and y polarization), and the 4×4 microwave network parameter matrix is constructed, the relationship between the scattering matrix, the transmission matrix, the wave matrix, and the field quantity is established, respectively;
the scattering matrix S is used to establish the relationship between the incident wave and the reflected wave in region 1 and region n+1, which is expressed as:

$$( \begin{matrix}{E}_{1}^{-} \\ {E}_{n + 1}^{+}\end{matrix} ) = ( \begin{matrix}{S}_{11} & {S}_{12} \\ {S}_{21} & {S}_{22}\end{matrix} ) ( \begin{matrix}{E}_{1}^{+} \\ {E}_{n + 1}^{-}\end{matrix} ) ;$$

where

$${E}_{1}^{-}$$

denotes the backward propagation electric field vector in region 1;

$${E}_{n + 1}^{+}$$

denotes the forward propagation electric field vector in region n+1;

$${E}_{1}^{+}$$

denotes the forward propagation electric field vector in region 1;

$${E}_{n + 1}^{-}$$

denotes the backward propagation electric field vector in region n+1;

$$( \begin{matrix}{S}_{11} & {S}_{12} \\ {S}_{21} & {S}_{22}\end{matrix} )$$

denotes the scattering matrix, the scattering matrix is used to describe the parameter matrix of electromagnetic scattering characteristics of the four-port network;
the transmission matrix ABCD is used to establish the relationship between the total electric field and magnetic field in region 1 and region n+1, which is expressed as:

$$( \begin{matrix}{E}_{1}^{+} + {E}_{1}^{-} \\ \frac{1}{{η}_{i}} n ( {E}_{1}^{+} - {E}_{1}^{-} )\end{matrix} ) = ( \begin{matrix}A & B \\ C & D\end{matrix} ) ( \begin{matrix}{E}_{n + 1}^{+} + {E}_{n + 1}^{-} \\ \frac{1}{{η}_{i + 1}} n ( {E}_{n + 1}^{+} - {E}_{n + 1}^{-} )\end{matrix} ) ;$$

where

$$( \begin{matrix}A & B \\ C & D\end{matrix} )$$

denotes the transmission matrix, the transmission matrix is used to describe the parameter matrix of the electromagnetic transmission characteristics of the four-port network;
the wave matrix is used to establish the field relationship between the incident/reflected field of region 1 and the field of region n+1, which is expressed as:

$$( \begin{matrix}{E}_{1}^{+} \\ {E}_{1}^{-}\end{matrix} ) = ( \begin{matrix}{M}_{11} & {M}_{12} \\ {M}_{21} & {M}_{22}\end{matrix} ) ( \begin{matrix}{E}_{n + 1}^{+} \\ {E}_{n + 1}^{-}\end{matrix} ) ;$$

where

$$( \begin{matrix}{M}_{11} & {M}_{12} \\ {M}_{21} & {M}_{22}\end{matrix} )$$

denotes the wave matrix, the wave matrix is the parameter matrix used to describe a relationship between forward and backward electric field vectors in different regions of the cascaded metasurface electromagnetic structure;
then, the correlation expressions of the wave matrix and scattering matrix S, wave matrix, and transmission matrix ABCD are derived, and the transformation of traditional network parameters to the wave matrix is realized, which is as follows:

$$𝕄 = {𝕊}_{1} {𝕊}_{2}^{- 1} = ( \begin{matrix}I & 0 \\ {S}_{11} & {S}_{12}\end{matrix} ) {( \begin{matrix}{S}_{21} & {S}_{22} \\ 0 & I\end{matrix} )}^{- 1} ; \\ 𝕄 = \frac{1}{2} ( \begin{matrix}I & - {η}_{1} n \\ I & {η}_{1} n\end{matrix} ) ( \begin{matrix}A & B \\ C & D\end{matrix} ) ( \begin{matrix}I & I \\ \frac{1}{{η}_{n + 1}} n & - \frac{1}{{η}_{n + 1}} n\end{matrix} ) ;$$

where

$${𝕊}_{1} {𝕊}_{2}^{- 1}$$

denotes the block of the scattering matrix; I denotes the unit matrix; 0 denotes the zero matrix; η₁ denotes the intrinsic impedance corresponding to region 1; ηₙ₊₁ denotes the intrinsic impedance corresponding to the region n+1;
the functions of the wave matrices for the i-th interface and the dielectric spacer are clarified, and the forward/backward propagation fields of the region i and the region i+1 are correlated. Based on the composition of n−1 dielectric spacers and n thin-sheet admittance layers, the total wave matrix expression of the cascaded structure is obtained, and the logic of calculating the overall wave matrix by multiplying the wave matrices of each layer is determined; the total wave matrix expression of the cascaded structure is:

$$( \begin{matrix}{E}_{1}^{+} \\ {E}_{1}^{-}\end{matrix} ) = {𝕄}_{inter}^{( 1 )} {𝕄}_{delay}^{( 2 )} {𝕄}_{inter}^{( 2 )} … {𝕄}_{delay}^{( n )} {𝕄}_{inter}^{( n )} ( \begin{matrix}{E}_{n + 1}^{+} \\ {E}_{n + 1}^{-}\end{matrix} ) ;$$

where

$${𝕄}_{inter}^{( n )}$$

denotes the wave matrix of the n-th interface;

$${𝕄}_{delay}^{( n )}$$

denotes the wave matrix of the n-th dielectric delay;
the wave matrix expression of each component is derived for each scene;

Scenario 1: When only considering the electrical response and in the absence of cross-polarization, based on the boundary conditions, combined with the material interface 2×2 transmission matrix (including the Fresnel reflection coefficient r and transmission coefficient t), the identity matrix, and the surface ideal electromagnetic response admittance value, the wave matrix of the i-th layer interface is derived, the calculation formula is:

$${𝕄}_{inter}^{( i )} = ( {T}_{i} ⊗ I + \frac{{η}_{i}}{2} e ⊗ {Y}_{i} ) ; \\ {T}_{i} = ( 1 / t ) ( \begin{matrix}1 & r \\ r & 1\end{matrix} ) ;$$

where Tᵢ denotes the 2×2 transmission matrix of the material interface; r denotes the Fresnel reflection coefficient; t denotes the transmission coefficient;

$$e = [ \begin{matrix}1 & 1 \\ - 1 & - 1\end{matrix} ] ;$$

Yᵢ denotes the 2×2 admittance value of the surface ideal electromagnetic response

$${Y}_{i} = [ \begin{matrix}{Y}_{i}^{xx} & 0 \\ 0 & {Y}_{i}^{yy}\end{matrix} ] ;$$

⊗ denotes the Kronecker product;

Scenario 2: When only considering the magnetic response, the wave matrix of the i-th layer interface is derived, and the calculation formula is:

$${𝕄}_{inter}^{( i )} = ( {T}_{i} ⊗ I + \frac{1}{2 {η}_{i + 1}} m ⊗ ( n {Z}_{i} n ) ) ;$$

where m denotes the matrix factor; Zᵢ denotes the surface impedance of the i-th interface;

Scenario 3: Assuming plane wave propagation within the dielectric medium spacers, combined with relevant parameters, the wave matrix of the dielectric spacer is derived, the calculation formula is:

$${𝕄}_{d e l a y}^{( i )} = ( {Φ}_{i} ⊗ I ) ;$$

where Φᵢ denotes the phase delay matrix associated with the i-th dielectric spacer;
taking the electrically responsive metasurface (i=3) as an example, the total wave matrix of the cascaded structure is obtained by substituting the wave matrix expression of the interfaces and the dielectric spacers, which is expressed as

$${𝕄}_{total} = {𝕄}_{inter}^{( 1 )} {𝕄}_{d e l a y}^{( 2 )} {𝕄}_{inter}^{( 2 )} {𝕄}_{d e l a y}^{( 3 )} {𝕄}_{inter}^{( 3 )} ;$$

where [symbol] ₜₒₜₐₗ denotes the total wave matrix of the cascaded structure;
the scattering matrix S is associated with the total wave matrix of the cascaded structure, which is expressed as:

$${𝕄}_{total} = {𝕊}_{1} {𝕊}_{2}^{- 1} = {𝕄}_{inter}^{( 1 )} {𝕄}_{d e l a y}^{( 2 )} {𝕄}_{inter}^{( 2 )} {𝕄}_{d e l a y}^{( 3 )} {𝕄}_{inter}^{( 3 )} ;$$

considering a cross-medium scenario, the isolation medium is introduced after the last layer of the metasurface, and the total wave matrix and the corresponding scattering matrix S correlation of the cascaded structure are modified, which is expressed as:

$${𝕄}_{total} = {𝕄}_{inter}^{( 1 )} {𝕄}_{d e l a y}^{( 2 )} {𝕄}_{inter}^{( 2 )} {𝕄}_{d e l a y}^{( 3 )} {𝕄}_{inter}^{( 3 )} {𝕄}_{d e l a y}^{( 4 )} {𝕄}_{inter}^{( 4 )} ;$$

$${𝕄}_{d e l a y}^{( 4 )} = ( {Φ}_{4} ⊗ I ) ;$$

$${𝕄}_{inter}^{( 4 )} = ( {T}_{4} ⊗ I ) ;$$

$${𝕊}_{I} {{𝕊}_{2}^{- 1} ( {T}_{4} ⊗ I )}^{- 1} {( {Φ}_{4} ⊗ I )}^{- 1} = {𝕄}_{inter}^{( 1 )} {𝕄}_{d e l a y}^{( 2 )} {𝕄}_{inter}^{( 2 )} {𝕄}_{d e l a y}^{( 3 )} {𝕄}_{inter}^{( 3 )} ;$$

where

$${𝕄}_{inter}^{( 1 )} , {𝕄}_{inter}^{( 2 )} , {𝕄}_{inter}^{( 3 )} , and {𝕄}_{inter}^{( 4 )}$$

denote the wave matrices for the first, second, third, and fourth interface, respectively;

$${𝕄}_{inter}^{( 2 )} , {𝕄}_{inter}^{( 3 )} , and {𝕄}_{inter}^{( 4 )}$$

denote the wave matrices for the second, third, and fourth dielectric delay, respectively; and Φ₄ denotes the phase delay matrix of the fourth dielectric spacer; T₄ denotes the transmission matrix block related to the fourth interface.
the wave matrix of the interface and the wave matrix of the dielectric spacer are substituted into the modified scattering matrix S correlation to solve the key parameters Y₁, Y₂, and Y₃.

Simultaneously, the technical effects are verified through coding regulation (deriving the ideal admittance values for four 2-bit coded non-reflective broadband metasurface states), broadband impedance matching (achieving the −3 dB bandwidth of 5.75-8.15 GHz), and ultra-low profile design (thickness 0.058λ), the modeling and analysis are validated by combining simulation comparisons (such as the transmission coefficient with and without the metasurface, and oblique incidence response).

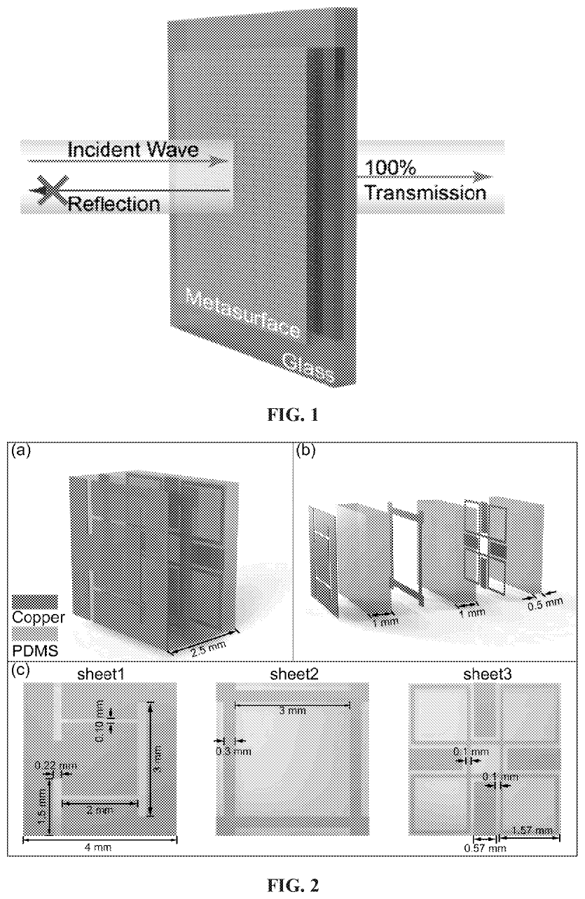

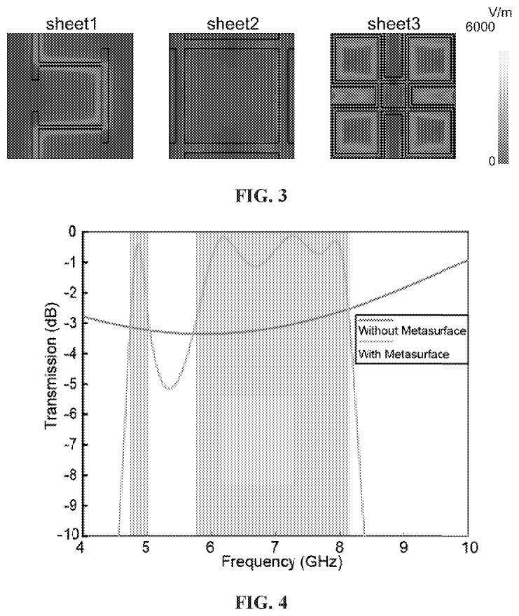

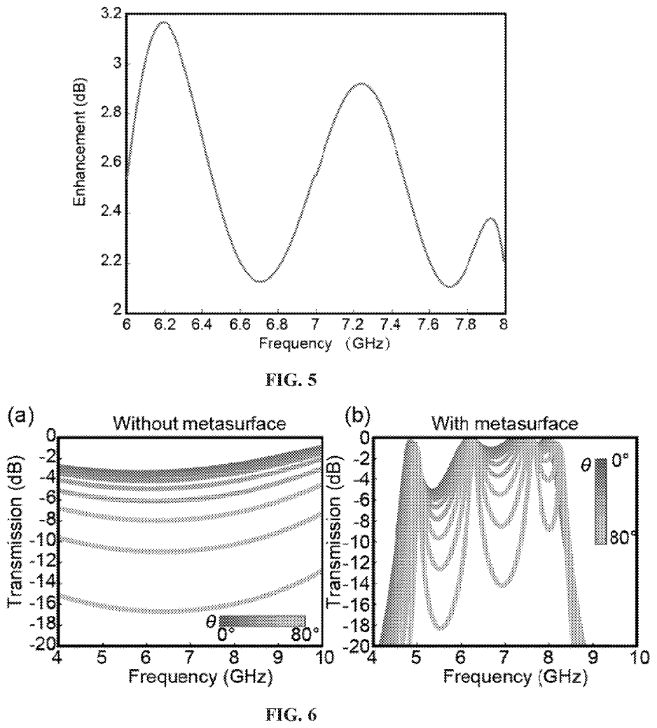

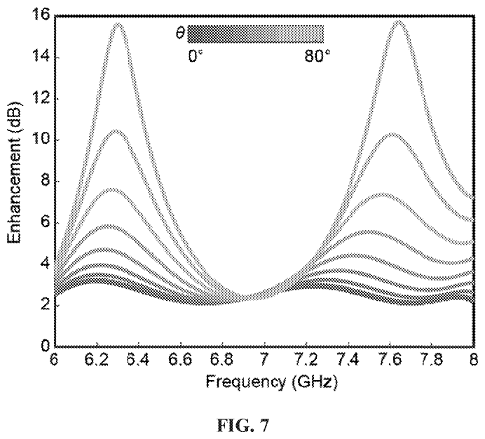

As shown in FIGS. 1-7, to achieve mechanical flexibility of the metasurface, the flexible polymer material PDMS is selected as the dielectric spacers in this embodiment. During the simulation design phase, the metasurface patterns of each layer are modeled as perfect electric conductor (PEC) to ensure the design's feasibility and the accuracy of the electromagnetic response;
the metasurface adopts the three-layer cascaded metal pattern structure, where the thickness of the PDMS substrate between the adjacent two metal patterns is 1 mm, the thickness of the outermost PDMS substrate is 0.5 mm, and the total thickness of the overall metasurface is controlled to be 2.5 mm (corresponding to the wavelength of 0.058λ). At the same time, the size of the metasurface unit is set to 4 mm (corresponding to the wavelength of 0.093λ). This size design ensures that even if the layer spacing is small, the electromagnetic wave incident on each layer of the metasurface may still be approximated as a plane wave to meet the subsequent regulation requirements;
after obtaining the scattering parameters used to define the state of the transmission field, four transmission states with a phase difference of 900 may be further obtained and defined as “00”, “01”, “10”, and “11”, respectively. Subsequently, by analyzing the cascaded structure through the wave matrix model, the ideal admittance values of each metasurface layer under different transmission states may be calculated. This provides a critical basis for the design and optimization of each layer's structure, ultimately achieving precise control over the incident electromagnetic waves.

Therefore, the present disclosure adopts the above-mentioned wave matrix-based cascaded metasurface electromagnetic transmission modeling and analysis method, as well as a cascaded metasurface. The device achieves flexible regulation of 5.75-8.15 GHz-3 dB bandwidth and 0°-80° oblique incidence, establishing a signal enhancement system framework across building surfaces; this method improves the transmission efficiency of electromagnetic waves through glass curtain walls while reducing deployment and maintenance costs. Furthermore, this method endows metasurfaces with mechanical adaptability, enhancing compatibility with glass curtain walls and supporting large-scale deployment in complex scenarios.

Finally, it should be noted that the above embodiments are only intended to illustrate the technical solution of the present disclosure, not to limit it. Although the present disclosure has been described in detail with reference to the preferred embodiments, those of ordinary skill in the art should understand that modifications or equivalent substitutions can still be made to the technical solution of the present disclosure; however, such modifications or equivalent substitutions cannot cause the modified technical solution to depart from the spirit and scope of the technical solution of the present disclosure.

What is claimed is:

1. A wave matrix-based cascaded metasurface electromagnetic transmission modeling and analysis method, comprising:
a cascaded structure is defined as consisting of dielectric spacers and n thin-sheet admittance layers, wherein a total electric field within each region is considered as a sum of a forward propagation field
$${E}_{i}^{+}$$
and a backward propagation field
$${E}_{i}^{-} ,$$
expressed as:
$${E}_{i} = {E}_{i}^{+} + {E}_{i}^{-} ;$$
$${E}_{i}^{+} = {[ \begin{matrix}{E}_{i x}^{+} & {E}_{i y}^{+}\end{matrix} ]}^{T} ;$$
$${E}_{i}^{-} = {[ \begin{matrix}{E}_{i x}^{-} & {E}_{i y}^{-}\end{matrix} ]}^{T} ;$$
wherein Eᵢ denotes the total electric field within the region,
$${E}_{i x}^{+}$$
denotes an x-direction component of a forward propagation electric field in region i;
$${E}_{i y}^{+}$$
denotes a y-direction component of the forward propagation electric field in region i;
$${E}_{i x}^{-}$$
denotes an x-direction component of a backward propagation electric field in region i, and
$${E}_{i y}^{-}$$
denotes a y-direction component of the backward propagation electric field in region i;
a corresponding magnetic field expression is derived by incorporating a 90° rotation matrix, establishing a mathematical relationship between the total electric field and magnetic field in region i; expressed as:
$${H}_{i}^{+} = \frac{1}{{η}_{i}} n {E}_{i}^{+} , {H}_{i}^{-} = - \frac{1}{{η}_{i}} {nE}_{i}^{-} ;$$
$$n = [ \begin{matrix}0 & - 1 \\ 1 & 0\end{matrix} ] ;$$
wherein n denotes the 90° rotation matrix;
$${E}_{i}^{+}$$
denotes a forward propagation electric field vector in region i;
$${E}_{i}^{-}$$
denotes a backward propagation electric field vector in region i;
$${H}_{i}^{+}$$
denotes a forward propagation magnetic field vector in region i;
$${H}_{i}^{+}$$
denotes a backward propagation magnetic field vector in region i; ηᵢ denotes an intrinsic impedance;
a total magnetic field is expressed as:
$${H}_{i} = {H}_{i}^{+} + {H}_{i}^{-} = \frac{1}{{η}_{i}} n ( {E}_{i}^{+} - {E}_{i}^{-} ) ;$$
wherein Hᵢ denotes a total magnetic field in region i;
the cascaded structure is equivalent to a four-port network, the ports are arranged in region 1 and region n+1, and x-polarization along with y-polarization are considered at the same time, a 4×4 microwave network parameter matrix is constructed to establish a correlation between an incident wave and a reflected wave;
using a wave matrix to correlate with a scattering matrix and a transmission matrix respectively, wherein the scattering matrix correlates the incident wave with the reflected wave of region 1 and region n+1, the transmission matrix correlates the total electric field and magnetic field of region 1 and region n+1, the wave matrix directly correlates an incident/reflected field of region 1 and a field of region n+1;
wave matrices for the i-th interface and dielectric spacers are defined, according to a definition of wave matrix, the forward/backward propagation field of region i is correlated with the field of region i+1, and a total wave matrix of cascaded structure is obtained by combining wave matrices of n−1 dielectric spacers and n thin-sheet admittance layers through matrix multiplication; the total wave matrix of the cascaded structure is expressed as:
$$( \begin{matrix}{E}_{i}^{+} \\ {E}_{i}^{-}\end{matrix} ) = {𝕄}_{inter}^{( 1 )} {𝕄}_{delay}^{( 2 )} {𝕄}_{inter}^{( 2 )} … {𝕄}_{delay}^{( n )} {𝕄}_{inter}^{( n )} ( \begin{matrix}{E}_{n + 1}^{+} \\ {E}_{n + 1}^{-}\end{matrix} ) ;$$
wherein
$${𝕄}_{inter}^{( n )}$$
denotes a wave matrix of the n-th interface;
$${𝕄}_{delay}^{( n )}$$
denotes a wave matrix of the n-th dielectric delay;
$${E}_{n + 1}^{+}$$
is a forward propagation electric field vector in region n+1;
$${E}_{n + 1}^{-}$$
is a backward propagation electric field vector in region n+1;
based on boundary conditions, a wave matrix of an interface of the i-th layer is derived, and a wave matrix expression of each component is derived according to a scene, under an assumption of plane wave propagation in the dielectric spacer, a wave matrix of the dielectric spacer is calculated;
after last layer of metasurface, an isolation medium is introduced to modify expression of the total wave matrix and the associated scattering matrix of the cascaded structure, the wave matrix of the interface and the wave matrix of the dielectric spacer are substituted into modified expression to solve key parameters that characterize an electromagnetic response and complete the modeling.

2. The wave matrix-based cascaded metasurface electromagnetic transmission modeling and analysis method according to claim 1, wherein a scattering matrix S is expressed as:
$$( \begin{matrix}{E}_{1}^{-} \\ {E}_{n + 1}^{+}\end{matrix} ) = ( \begin{matrix}{S}_{11} & {S}_{12} \\ {S}_{21} & {S}_{22}\end{matrix} ) ( \begin{matrix}{E}_{1}^{+} \\ {E}_{n + 1}^{-}\end{matrix} ) ;$$
wherein
$${E}_{1}^{-}$$
denotes a backward propagation electric field vector in region 1;
$${E}_{1}^{+}$$
denotes a forward propagation electric field vector in region 1;
$$( \begin{matrix}{S}_{11} & {S}_{12} \\ {S}_{21} & {S}_{22}\end{matrix} )$$
denotes the scattering matrix, the scattering matrix is used to describe a parameter matrix of electromagnetic scattering characteristics of the four-port network.

3. The wave matrix-based cascaded metasurface electromagnetic transmission modeling and analysis method according to claim 1, wherein the transmission matrix ABCD is expressed as:
$$( \begin{matrix}{E}_{1}^{+} + {E}_{1}^{-} \\ \frac{1}{{η}_{i}} n ( {E}_{1}^{+} - {E}_{1}^{-} )\end{matrix} ) = ( \begin{matrix}A & B \\ C & D\end{matrix} ) ( \begin{matrix}{E}_{n + 1}^{+} + {E}_{n + 1}^{-} \\ \frac{1}{{η}_{i + 1}} n ( {E}_{n + 1}^{+} - {E}_{n + 1}^{-} )\end{matrix} ) ;$$
wherein
$$( \begin{matrix}A & B \\ C & D\end{matrix} )$$
denotes the transmission matrix, the transmission matrix is used to describe a parameter matrix of the electromagnetic transmission characteristics of the four-port network.

4. The wave matrix-based cascaded metasurface electromagnetic transmission modeling and analysis method according to claim 1, wherein the wave matrix is expressed as:
$$( \begin{matrix}{E}_{1}^{+} \\ {E}_{1}^{-}\end{matrix} ) = ( \begin{matrix}{M}_{11} & {M}_{12} \\ {M}_{21} & {M}_{22}\end{matrix} ) ( \begin{matrix}{E}_{n + 1}^{+} \\ {E}_{n + 1}^{-}\end{matrix} ) ;$$
wherein
$$( \begin{matrix}{M}_{11} & {M}_{12} \\ {M}_{21} & {M}_{22}\end{matrix} )$$
denotes the wave matrix, the wave matrix is a parameter matrix used to describe a relationship between forward and backward electric field vectors in different regions of the cascaded metasurface electromagnetic structure.

5. The wave matrix-based cascaded metasurface electromagnetic transmission modeling and analysis method according to claim 1, wherein it also comprises a transformation of traditional network parameters to wave matrix, specifically as follows:
$$𝕄 = {𝕊}_{1} {𝕊}_{2}^{- 1} = ( \begin{matrix}I & 0 \\ {S}_{11} & {S}_{12}\end{matrix} ) {( \begin{matrix}{S}_{21} & {S}_{22} \\ 0 & I\end{matrix} )}^{- 1} ;$$
$$𝕄 = \frac{1}{2} ( \begin{matrix}I & - {η}_{1} n \\ I & {η}_{1} n\end{matrix} ) ( \begin{matrix}A & B \\ C & D\end{matrix} ) ( \begin{matrix}I & I \\ \frac{1}{{η}_{n + 1}} n & - \frac{1}{{η}_{n + 1}} n\end{matrix} ) ;$$
wherein
$${𝕊}_{1} {𝕊}_{2}^{- 1}$$
denotes a block of the scattering matrix; I denotes a unit matrix; 0 denotes a zero matrix; η₁ denotes an intrinsic impedance corresponding to region 1; and ηₙ₊₁ denotes an intrinsic impedance corresponding to the region n+1.

6. The wave matrix-based cascaded metasurface electromagnetic transmission modeling and analysis method according to claim 1, wherein the wave matrix expression of each component is derived according to scenes, specifically as follows:
Scenario 1: when only considering an electrical response and not considering a cross-polarization, a transmission matrix of a material interface is calculated as follows:
$${𝕄}_{inter}^{( i )} = ( {T}_{i} ⊗ I + \frac{{η}_{i}}{2} e ⊗ {Y}_{i} ) ;$$
$${T}_{i} = ( 1 / t ) ( \begin{matrix}1 & r \\ r & 1\end{matrix} ) ;$$
wherein Tᵢ denotes a 2×2 transmission matrix of the material interface; r denotes a Fresnel reflection coefficient; t denotes a transmission coefficient;
$$e = [ \begin{matrix}1 & 1 \\ - 1 & - 1\end{matrix} ] ; {Y}_{i}$$
denotes a 2×2 admittance value of a surface ideal electromagnetic response
$${Y}_{i} = [ \begin{matrix}{Y}_{i}^{x x} & 0 \\ 0 & {Y}_{i}^{y y}\end{matrix} ] ;$$
⊗ denotes a Kronecker product;
Scenario 2: unit matrix and surface ideal electromagnetic response admittance value are calculated, a calculation formula is:
$${𝕄}_{inter}^{( i )} = ( {T}_{i} ⊗ I + \frac{1}{2 {η}_{i + 1}} m ⊗ ( n {Z}_{i} n ) ) ;$$
wherein m denotes a matrix factor; Zᵢ denotes a surface impedance of the i-th interface;
Scenario 3: the specific boundary conditions are derived when only considering the magnetic response, and a calculation formula is:
$${𝕄}_{d e l a y}^{( i )} = ( {Φ}_{i} ⊗ I ) ;$$
wherein Φᵢ denotes a phase delay matrix associated with the i-th dielectric spacer.

7. The wave matrix-based cascaded metasurface electromagnetic transmission modeling and analysis method according to claim 1, wherein it also comprises, combined with an electrically responsive metasurface, when i=3, the total wave matrix of the cascaded structure is expressed as:
$${𝕄}_{t otal} = {𝕄}_{inter}^{( 1 )} {𝕄}_{d e l a y}^{( 2 )} {𝕄}_{inter}^{( 2 )} {𝕄}_{d e l a y}^{( 3 )} {𝕄}_{inter}^{( 3 )} ;$$
wherein [symbol] ₜₒₜₐₗ denotes the total wave matrix of the cascaded structure;
the scattering matrix S is associated with the total wave matrix of the cascaded structure, which is expressed as:
$${𝕄}_{t otal} = {𝕊}_{1} {𝕊}_{2}^{- 1} = {𝕄}_{inter}^{( 1 )} {𝕄}_{d e l a y}^{( 2 )} {𝕄}_{inter}^{( 2 )} {𝕄}_{d e l a y}^{( 3 )} {𝕄}_{inter}^{( 3 )} ;$$
considering a cross-medium scenario, the isolation medium is introduced after the last layer of the metasurface, and the total wave matrix and the corresponding scattering matrix S correlation of the cascaded structure are modified, and expressed as:
$${𝕄}_{t otal} = {𝕄}_{inter}^{( 1 )} {𝕄}_{d e l a y}^{( 2 )} {𝕄}_{inter}^{( 2 )} {𝕄}_{d e l a y}^{( 3 )} {𝕄}_{inter}^{( 3 )} {𝕄}_{d e l a y}^{( 4 )} {𝕄}_{inter}^{( 4 )} ;$$
$${𝕄}_{d e l a y}^{( 4 )} = ( {Φ}_{4} ⊗ I ) ;$$
$${𝕄}_{inter}^{( 4 )} = ( {T}_{4} ⊗ I ) ;$$
$${𝕊}_{1} {{𝕊}_{2}^{- 1} ( {T}_{4} ⊗ I )}^{- 1} {( {Φ}_{4} ⊗ I )}^{- 1} = {𝕄}_{inter}^{( 1 )} {𝕄}_{d e l a y}^{( 2 )} {𝕄}_{inter}^{( 2 )} {𝕄}_{d e l a y}^{( 3 )} {𝕄}_{inter}^{( 3 )} ;$$
wherein
$${𝕄}_{inter}^{( 1 )} , {𝕄}_{inter}^{( 2 )} , {𝕄}_{inter}^{( 3 )} , and {𝕄}_{inter}^{( 4 )}$$
denote wave matrices for the first, second, third, and fourth interface, respectively;
$${𝕄}_{inter}^{( 2 )} , {𝕄}_{inter}^{( 3 )} , and {𝕄}_{inter}^{( 4 )}$$
denote the wave matrices for the second, third, and fourth dielectric delay, respectively; and Φ₄ denotes a phase delay matrix of the fourth dielectric spacer. T₄ denotes a transmission matrix block related to the fourth interface.

8. A cascaded metasurface according to claim 1, the cascaded metasurface is designed based on an ideal admittance value of a “11” state, comprising three thin-sheet admittance layers and dielectric spacers, a flexible material, polydimethylsiloxane (PDMS), is used as a substrate, and a thickness is 0.058λ.

9. The cascaded metasurface according to claim 8, wherein the cascaded metasurface achieves impedance matching of an air-glass interface in the −3 dB bandwidth of the RF, microwave, and millimeter-wave bands.
